(19) United States
(12) Patent Application Publication
(10) Pub. No.: US 2012/0117406 A1
(43) Pub. Date: May 10, 2012

(54) METHOD AND APPARATUS FOR MEMORY MANAGEMENT IN MOBILE DEVICE

(75) Inventor: Gee Sung Eun, Suwon-si (KR)

(73) Assignee: SAMSUNG ELECTRONICS CO. LTD., Suwon-si (KR)

(21) Appl. No.: 13/292,338

(22) Filed: Nov. 9, 2011

(30) Foreign Application Priority Data
Nov. 9, 2010 (KR) 10-2010-0110943

(51) Int. Cl. G06F 1/32; G06F 12/02

(52) U.S. Cl. 713/323; 711/170; 711/E12.009

(57) ABSTRACT

A method for memory management in a mobile device, and a mobile device for performing the method, are provided. The mobile device performs garbage collection in a flexible manner after transitioning from the sleep state to the wakeup state according to the paging cycle. This contributes to securing the sleep interval for the mobile device and reducing power consumption. The memory management method includes transitioning from a sleep state to a wakeup state, performing a paging procedure in the wakeup state, determining whether to initiate garbage collection after completion of the paging procedure, performing, when it is determined that garbage collection is to be initiated, garbage collection according to a paging cycle, and transitioning from the wakeup state to the sleep state after completion of garbage collection.

### PRIORITY

This application claims the benefit under 35 U.S.C. §119(a) of a Korean patent application filed on Nov. 9, 2010 in the Korean Intellectual Property Office and assigned Serial No. 10-2010-0110943, the entire disclosure of which is hereby incorporated by reference.

### BACKGROUND OF THE INVENTION

1. Field of the Invention

The present invention relates to memory management in a mobile device. More particularly, the present invention relates to a method and apparatus that enable a mobile device using garbage collection to effectively perform memory management with reduced power consumption.

2. Description of the Related Art

Rapid advances in information, communication, and semiconductor technologies have enabled widespread popularization of mobile devices. In particular, high-end mobile devices have evolved into mobile convergence devices supporting heterogeneous functions originating from distinct fields. For example, mobile communication terminals may support not only regular communication functions related to voice calls and messages but also other functions including multimedia functions related to mobile broadcast reception via Digital Multimedia Broadcasting (DMB) or Digital Video Broadcasting (DVB), music playback functions using an audio player, a photography function, an Internet access function, and a dictionary search function.

A mobile device may use various types of memories. The mobile device may be allowed to write data in memory in units of bytes or words, but may be allowed to erase data from memory only in units of sectors. To manage a memory having such properties, an Embedded File System (EFS) divides the memory space into blocks of a given size and associates each block with a header indicating contents of the block.

To change the contents of a block, instead of directly writing new data to the block, the EFS treats the block as a dirty block or garbage, allocates an empty free block, and writes the new data to the free block. As garbage increases with repeated data removal or change, the number of free blocks available to the user decreases. Hence, garbage collection is performed to reclaim memory space.

In a typical mobile device, garbage collection is periodically performed according to a timer. In such a case, the mobile device may be forced to transition from a sleep state to a wakeup state for garbage collection, even in a sleep interval during which no user action is performed. In other words, the mobile device may transition from the sleep state to the wakeup state for each garbage collection period, causing a reduction in the actual sleep interval during which the mobile device is to remain in the sleep state. This may cause the mobile device to consume more power than necessary.

### SUMMARY OF THE INVENTION

Aspects of the present invention have been made to address the above-mentioned problems and/or disadvantages and to provide the advantages described below. Accordingly, an aspect of the present invention is to provide a mobile device that can perform memory management using garbage collection and a memory management method for the same.

Another aspect of the present invention is to provide a mobile device that can efficiently perform memory management with significantly reduced power consumption and a memory management method for the same.

Another aspect of the present invention is to provide a method and apparatus that enable a mobile device to reduce power consumption during memory management using garbage collection.

Another aspect of the present invention is to provide a memory management method and apparatus that enable a mobile device to perform garbage collection when a mobile device transitions from a sleep state to a wakeup state according to a paging cycle.

Another aspect of the present invention is to provide a memory management method and apparatus that enable a mobile device to perform garbage collection in a variable fashion when the mobile device transitions from a sleep state to a wakeup state according to the paging cycle.

Another aspect of the present invention is to provide a memory management method and apparatus that enable a mobile device to adjust the number of dirty blocks to be garbage-collected when the mobile device performs garbage collection during a wakeup state according to the paging cycle.

Another aspect of the present invention is to provide a mobile device that enhances usability and convenience by realizing an optimum environment for garbage collection in consideration of power consumption and a memory management method for the same.

In accordance with an aspect of the present invention, a method of memory management for a mobile device is provided. The method includes transitioning from a sleep state to a wakeup state, performing a paging procedure in the wakeup state, determining whether to initiate garbage collection after completion of the paging procedure, performing, when it is determined that garbage collection is to be initiated, garbage collection according to a paging cycle, and transitioning from the wakeup state to the sleep state after completion of garbage collection.

In accordance with another aspect of the present invention, a non-transitory computer readable storage media that contains computer programs implementing the above method is provided.

In accordance with another aspect of the present invention, a mobile device is provided. The device includes a communication module for communicating paging related data with a network through an established communication channel, a memory unit for storing programs and data related to garbage collection, and whose space is divided into valid blocks, dirty blocks and free blocks, and a control unit for controlling state transitions of the mobile device between a sleep state and a wakeup state, and for controlling, in the wakeup state, a process of performing garbage collection for dirty blocks in the memory unit according to a paging cycle agreed upon between the mobile device and the network.

In a feature of the present invention, the memory management method enables a mobile device to perform memory management using flexible garbage collection with reduced power consumption. The mobile device may perform garbage collection in a more efficient manner to reclaim memory space with reduced power consumption.

In a feature of the present invention, the mobile device performs garbage collection after transitioning from a sleep state to a wakeup state according to the paging cycle for synchronization with the network. Hence, the mobile device may reduce unnecessary state transitions to the wakeup state in the sleep interval and lengthen the actual sleep interval, thereby reducing power consumption.

That is, the mobile device performs garbage collection after transitioning from the sleep state to the wakeup state caused by inevitable synchronization with the network. Hence, the mobile device remains in the sleep state longer, thereby conserving power. In addition, dirty blocks are garbage-collected in a variable fashion according to the paging cycle determined by network conditions. That is, the number of dirty blocks to be garbage-collected is determined variably according to network conditions to secure the effective sleep interval, thereby reducing power consumption.

The memory management method may be applied to any device having a memory unit. A mobile device supporting the method may perform garbage collection in a more effective manner. Hence, the method may contribute to increased usability, convenience and competitiveness of a mobile device.

Other aspects, advantages, and salient features of the invention will become more apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings, in which:

FIG. 1 illustrates garbage collection operations according to an exemplary embodiment of the present invention;

FIG. 2 is a block diagram of a mobile device according to an exemplary embodiment of the present invention; and

FIG. 3 is a flowchart of a method for controlling garbage collection in a mobile device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention relate to a method and apparatus for memory management based on garbage collection in a mobile device. In particular, the mobile device supporting the method is allowed to perform garbage collection for restoring dirty blocks to free blocks after transitioning from the sleep state to the wakeup state according to the paging cycle. This contributes to securing the sleep interval for the mobile device and reducing unnecessary power consumption. In addition, the number of dirty blocks to be garbage-collected is adjusted flexibly according to the paging cycle determined by network conditions. Hence, garbage collection may be performed in a safe and efficient manner.

In one exemplary embodiment, for efficient memory management, the memory space may be divided into three types of blocks of a given size, namely valid blocks used to store useful data, dirty blocks used to store invalid data (the target for garbage collection), and free blocks for writing new data.

To change the data of a block, instead of directly writing new data (or additional data) to the block, the mobile device treats the block as a dirty block or garbage, allocates an empty free block, and writes the new data to the free block. As garbage increases with repeated data removal or change, the number of free blocks available to the user decreases. Hence, it is beneficial to perform garbage collection to remove garbage and reclaim memory space.

Next, a description is given of a configuration and operations of a mobile device with reference to the drawings. However, the configuration and operations thereof are not limited to or by the following description, and various changes and modifications are possible on the basis of the following description.

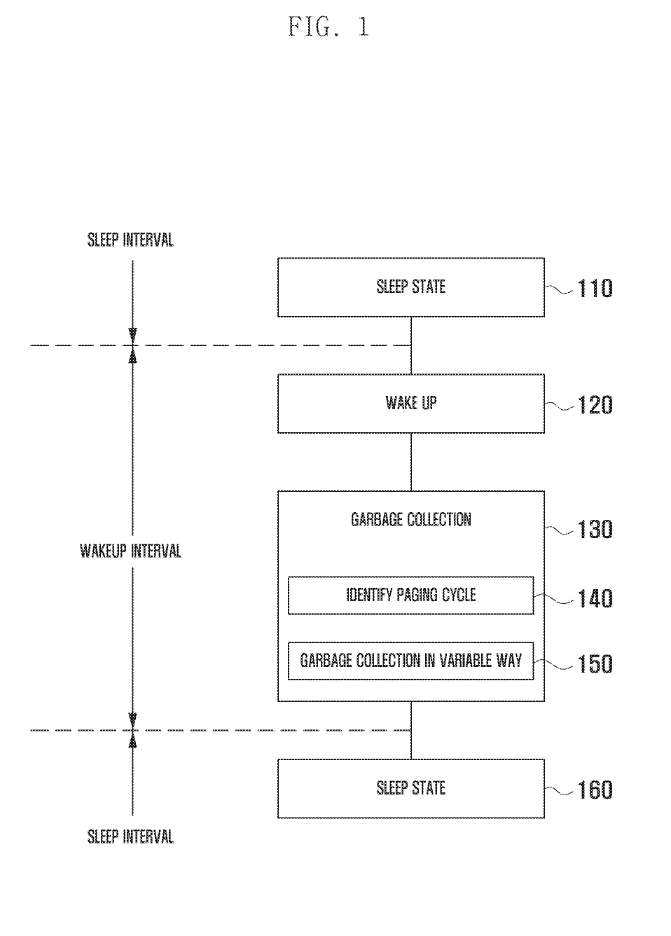

FIG. 1 illustrates garbage collection operations according to an exemplary embodiment of the present invention.

Referring to FIG. 1, when no user action is performed, a mobile device may remain in the sleep state to save power. That is, the mobile device may be in the sleep interval. The mobile device may transition to the wakeup state when a time for paging with the network arrives in the sleep interval. That is, the mobile device may be in the wakeup interval.

In the present exemplary embodiment, garbage collection is not performed in a rigid manner according to a timer. Instead, garbage collection is performed only in the wakeup interval and is skipped in the sleep interval.

As shown in FIG. 1, when no user action is performed for a preset time, the mobile device may transition to the sleep state and remain in the sleep interval in step 110. Later, when the paging cycle designed for synchronization with the network arrives, the mobile device may transition to the wakeup state and remain in the wakeup interval in step 120. The mobile device may perform a paging procedure with the network in the wakeup interval.

When the paging procedure is ended, the mobile device may perform garbage collection in step 130. Here, for garbage collection, the mobile device examines the paging cycle in step 140, and may conduct garbage collection in a flexible manner according to the paging cycle in step 150. For example, the mobile device may determine the number of dirty blocks to be garbage-collected in consideration of the length of the paging cycle and conduct garbage collection accordingly. This garbage collection will be described in more detail further below.

When garbage collection is completed in the wakeup interval, the mobile device may transition to the sleep state and remain in the sleep interval in step 160.

In the above description, the sleep interval, the wakeup interval, the sleep state and the wakeup state are defined for ease of description. State transitions of a mobile device according to paging cycles are known to those skilled in the art, and thus a detailed description thereof will be omitted.

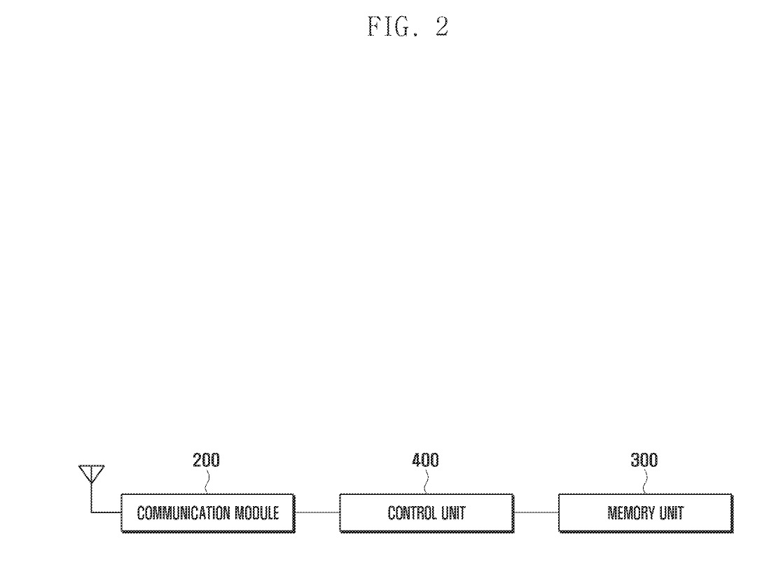

FIG. 2 is a block diagram of a mobile device according to an exemplary embodiment of the present invention.

Referring to FIG. 2, the mobile device includes a communication module 200, a memory unit 300, and a control unit 400. Although not shown, the mobile device may further include various components, such as a display unit for displaying screen data generated in the course of using the mobile device, an audio processing unit including a microphone and a speaker, a digital broadcast receiving module for Digital Multimedia Broadcasting (DMB) or Digital Video Broadcasting (DVB), a camera module for capturing still and moving images, a Bluetooth module for Bluetooth communication, an Internet module for Internet access, a touch pad for entering touch-based inputs, an input unit for physical key input, and a battery for supplying power. These additional components are not described further.

The communication module 200 is used to provide communication services for mobile communication. The communication module 200 may establish a communication channel to a network to which the mobile device is subscribed, and send and receive data through the communication channel. In particular, the communication module 200 may receive a paging message from the corresponding network according to a preset paging cycle. That is, the communication module 200 may remain in the sleep state in the sleep interval, wake in the wakeup interval and communicate with the network for paging-related operation in the wakeup state.

The memory unit 300 stores various programs and associated data related to operation of the mobile device. The memory unit 300 may be composed of one or more volatile and nonvolatile memory elements. Here, the nonvolatile memory elements may include a Read Only Memory (ROM) and a flash memory. The volatile memory elements may include a Random Access Memory (RAM). The memory unit 300 may temporarily or permanently store the operating system of the mobile device, programs and data related to the paging procedure, and programs and data related to garbage collection. For example, the memory unit 300 may store values for paging with the network (for example, cycle duration and timer settings), and a Threshold Value (TH) for activating garbage collection.

In particular, the memory space of the memory unit 300 may be divided into three types of blocks, namely valid blocks for storing useful data, dirty blocks for storing invalid data (garbage), and free blocks available for the writing of new data. The number of blocks in each type may be varied in the course of operation of the mobile device.

The control unit 400 controls the overall operations of the mobile device. In particular, the control unit 400 may control memory management operations in consideration of power consumption. The control unit 400 may control garbage collection operations in a variable way according to the paging cycle. For example, the control unit 400 skips garbage collection when the mobile device is in the sleep state. When the mobile device wakes for paging with the network, the control unit 400 performs a paging procedure with the network in the wakeup state. After completion of the paging procedure, the control unit 400 performs garbage collection in the wakeup interval. After completion of garbage collection, the control unit 400 transitions to the sleep state and remains in the sleep interval. Here, when the number of dirty blocks is less than or equal to the TH in the wakeup interval, the control unit 400 may skip garbage collection and immediately transition to the sleep state.

In one exemplary embodiment, the number of dirty blocks to be garbage-collected may be determined in consideration of the paging cycle determined by network conditions, and garbage collection may be performed accordingly. The paging cycle may correspond to two to nine frames in a typical network. For example, when the paging cycle is set to two frames, as the sleep interval is short, a single block may be garbage-collected (1 block per paging cycle). When the paging cycle is set to nine frames, as the sleep interval is long, ten blocks may be garbage-collected (10 blocks per paging cycle). In this way, the mobile device may secure appropriate sleep intervals to thereby reduce power consumption, and increase memory management efficiency to thereby maintain performance.

This control operation of the control unit 400 is described further in connection with the memory management method. The control unit 400 may control regular operations of the mobile device. For example, when an application is activated, the control unit 400 may control execution of the application and display of data generated thereby. The control unit 400 may also control state transitions of the mobile device between the sleep state and the wakeup state according to the paging cycle.

The mobile device of FIG. 2 may be any mobile terminal, such as a bar type mobile terminal, a folder type mobile terminal, a slide type mobile terminal, a swing type mobile terminal or a flip type mobile terminal. The mobile device of exemplary embodiments of the present invention may be an information and communication appliance, such as a mobile communication terminal based on communication protocols supporting various communication systems, a tablet personal computer, or a smart phone.

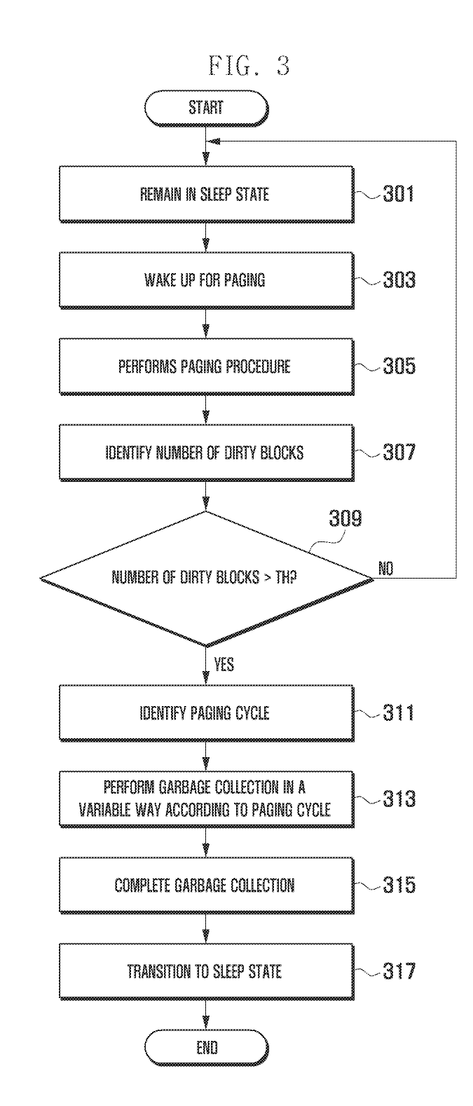

FIG. 3 is a flowchart of a method for controlling garbage collection in the mobile device according to an exemplary embodiment of the present invention.

Referring to FIG. 3, the mobile device remains in the sleep state in step 301. For example, when the user does not use the mobile device for a preset time or longer, the mobile device may transition to the sleep state. In the sleep state, the mobile device may have to wake for paging with the network.

When the paging cycle arrives, the control unit 400 transitions from the sleep state to the wakeup state in step 303. In the wakeup state, the control unit 400 performs a paging procedure with the network in step 305.

The control unit 400 identifies the number of dirty blocks in the memory unit 300 in step 307. The control unit 400 compares the number of dirty blocks with the TH preset for initiating garbage collection in step 309.

When the number of dirty blocks is less than or equal to the threshold value, the control unit 400 returns to step 301 and enters the sleep state. When the number of dirty blocks is greater than the threshold value, the control unit 400 identifies the paging cycle in step 311. Here, the paging cycle may be identified by checking frames received from the network during the wakeup state.

The control unit 400 controls garbage collection operations in a variable way according to the paging cycle in step 313. For example, the paging cycle may be set to two to nine frames according to network conditions. The control unit 400 may determine the number of dirty blocks to be processed per paging cycle and perform garbage collection accordingly.

The control unit 400 completes garbage collection in step 315 and transitions from the wakeup state to the sleep state in step 317.

As described above, the control unit 400 may perform garbage collection after completing the paging procedure in the wakeup state. To initiate garbage collection, the control unit 400 may examine the status of the memory unit 300. The control unit 400 may perform garbage collection in a variable way in consideration of the memory status and the paging cycle. For example, the control unit 400 may initiate garbage collection when the number of dirty blocks is greater than or equal to a set percent (e.g., 10 percent) of the total number of blocks in the memory unit 300.

According to exemplary embodiments of the present invention, the memory management method based on flexible garbage collection may be implemented as computer programs and may be stored in various non-transitory computer readable storage media. The non-transitory computer readable storage media may store program instructions, data files, data structures and combinations thereof. The program instructions may include instructions configured to be readable by at least one processor for instructing the at least one processor to execute a computer process for performing a method according to exemplary embodiments of the present invention. That is, the program instructions may be developed specifically for the exemplary embodiments of the present invention and may include existing general-purpose instructions.

The non-transitory computer readable storage media may include magnetic media such as a hard disk and floppy disk, optical media such as a Compact Disc (CD)-ROM and Digital Versatile Disc (DVD), magneto-optical media such as a floptical disk, and memory devices such as a ROM and RAM. The program instructions may include machine codes produced by compilers and high-level language codes executable through interpreters.

The description of the various embodiments is to be construed as exemplary only and does not describe every possible instance of the invention. Therefore, it should be understood that various changes may be made and equivalents may be substituted for elements of the exemplary embodiments of the present invention.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method of memory management for a mobile device, the method comprising:
transitioning from a sleep state to a wakeup state;
performing a paging procedure in the wakeup state;
determining whether to initiate garbage collection after completion of the paging procedure;
performing, when it is determined that garbage collection is to be initiated, garbage collection according to a paging cycle; and
transitioning from the wakeup state to the sleep state after completion of garbage collection.

2. The method of claim 1, wherein the performing of garbage collection comprises:
determining a number of dirty blocks to be processed according to the paging cycle; and
executing garbage collection for the determined number of dirty blocks.

3. The method of claim 2, wherein the executing of garbage collection comprises executing garbage collection for a variable time according to a length of the paging cycle.

4. The method of claim 1, wherein the determining of whether to initiate garbage collection comprises:
identifying a number of dirty blocks storing garbage data in a memory unit; and
comparing the identified number of dirty blocks with a threshold value preset for garbage collection.

5. The method of claim 4, further comprising:
determining, when the number of dirty blocks is greater than the threshold value, that garbage collection is to be initiated; and
transitioning, when the number of dirty blocks is not greater than the threshold value, from the wakeup state to the sleep state without performing garbage collection.

6. The method of claim 4, wherein the threshold value is a value that corresponds to a preset percentage of a total number of blocks.

7. At least one non-transitory computer readable storage media for storing a computer program of instructions configured to be readable by at least one processor for instructing the at least one processor to execute a computer process for performing the method as recited in claim 1.

8. A mobile device comprising:
a communication module for communicating paging related data with a network through an established communication channel;
a memory unit for storing programs and data related to garbage collection, and whose space is divided into valid blocks, dirty blocks and free blocks; and
a control unit for controlling state transitions of the mobile device between a sleep state and a wakeup state, and for controlling, in the wakeup state, a process of performing garbage collection for dirty blocks in the memory unit according to a paging cycle agreed upon between the mobile device and the network.

9. The mobile device of claim 8, wherein the control unit determines a number of dirty blocks to be processed according to the paging cycle in the wakeup state and controls an operation to conduct garbage collection for the determined number of dirty blocks.

10. The mobile device of claim 9, wherein the control unit examines the status of the memory unit after transitioning from the sleep state to the wakeup state, and determines whether to initiate garbage collection on the basis of the status of the memory unit.

11. The mobile device of claim 10, wherein the control unit determines to initiate garbage collection when the number of dirty blocks is greater than the threshold value.

12. The mobile device of claim 11, wherein the threshold value is a value that corresponds to a preset percentage of a total number of blocks in the memory unit.

13. The mobile device of claim 10, wherein the control unit performs, when it is determined that garbage collection is to be initiated, garbage collection for dirty blocks selected corresponding to the paging cycle, and transitions, when it is determined that garbage collection is not to be initiated, from the wakeup state to the sleep state.

14. The mobile device of claim 8, wherein the control unit transitions from the sleep state to the wakeup state and performs a paging procedure in the wakeup state before performing garbage collection.

15. The mobile device of claim 8, wherein the control unit transitions from the wakeup state to the sleep state after completion of garbage collection.
